(19) United States
(12) Patent Application Publication
(10) Pub. No.: US 2025/0216515 A1
(43) Pub. Date: Jul. 3, 2025

(54) LiDAR APPARATUS

(71) Applicant: SAMSUNG ELECTRONICS CO., LTD., Suwon-si (KR)

(72) Inventors: Hyunil BYUN, Suwon-si (KR); Woosung KIM, Suwon-si (KR); Changbum LEE, Suwon-si (KR)

(73) Assignee: SAMSUNG ELECTRONICS CO., LTD., Suwon-si (KR)

(21) Appl. No.: 18/737,283

(22) Filed: Jun. 7, 2024

(30) Foreign Application Priority Data
Dec. 28, 2023 (KR) 10-2023-0195608

(51) Int. Cl. G01S 7/481; G01S 7/484; G01S 17/931

(52) U.S. Cl. CPC G01S 7/4815; G01S 7/484; G01S 17/931

(57) ABSTRACT

Provided is a light detection and ranging (LiDAR) apparatus. The LiDAR apparatus includes a plurality of waveguides extending in a first direction and spaced apart from one another in a second direction crossing the first direction, a plurality of light sources spaced apart from one another in the second direction and having a first end optically connected to the plurality of waveguides respectively, a plurality of light switching elements that are two-dimensionally arranged, and having a plurality of first light switching elements optically connected to a first waveguide among the plurality of waveguides, a plurality of light input/output elements optically connected to the plurality of light switching elements, respectively, and a light steering element configured to steer incident light based on a position of incident light on the light steering element. The plurality of light input/output elements configured to input/output light in a third direction.

### CROSS-REFERENCE TO RELATED APPLICATION

This application is based on and claims priority under 35 U.S.C. § 119 to Korean Patent Application No. 10-2023-0195608, filed on Dec. 28, 2023, in the Korean Intellectual Property Office, the disclosure of which is incorporated by reference herein in its entirety.

### BACKGROUND

### 1. Field

Aspects of the disclosure relate to a light detection and ranging (LiDAR) apparatus that steers light.

### 2. Description of the Related Art

Recently, advanced driving assistance systems (ADAS) having various functions have been commercialized. For example, increasing number of vehicles equipped with functions such as an adaptive cruise control (ACC) and an autonomous emergency braking system (AEB) are on the market. The ACC function reduces a speed of a vehicle when there is a risk of collision and drives the vehicle within a set speed range when there is no risk of collision by recognizing a location and speed of another vehicle. The AEB function automatically applies braking to prevent collisions when there is a risk of collision by recognizing the vehicle in front, and a driver does not respond to the risk or the response method is inappropriate. Moreover, autonomous driving cars are expected to be commercialized in the near future.

Accordingly, the significance of a vehicle radar that provides forward information of a vehicle is increasing rapidly. For example, light detection and ranging (LIDAR) sensors are widely used as vehicle radars. The LiDAR sensors measure a distance, speed, azimuth, and position of an object based on the time when a laser scattered or reflected by the object returns to a vehicle, changes in the intensity of the laser, changes in the frequency of the laser, and changes in the polarization state of the laser.

### SUMMARY

Provided is a light detecting and ranging (LiDAR) apparatus that steers light by using a focal plane array method.

Additional aspects will be set forth in part in the description which follows and, in part, will be apparent from the description, or may be learned by practice of the presented embodiments of the disclosure.

According to an aspect of the disclosure, there is provided a light detection and ranging (LiDAR) apparatus including: a plurality of waveguides extending in a first direction, the plurality of waveguides spaced apart from one another in a second direction crossing the first direction; a plurality of light sources spaced apart from one another in the second direction, each of the plurality of light sources having a first end optically connected to a waveguide from among the plurality of waveguides, corresponding to the respective light source from the plurality of light sources; a plurality of light switching elements that are two-dimensionally spaced apart from one another in the first direction and the second direction, a plurality of first light switching elements, among the plurality of light switching elements, that are spaced apart from one another in the first direction are optically connected to a first waveguide among the plurality of waveguides; a plurality of light input/output elements optically connected to the plurality of light switching elements, respectively, the plurality of light input/output elements configured to output light in a third direction crossing the first direction and the second direction or receive external light; and a light steering element arranged in the third direction from the plurality of light input/output elements, the light steering element configured to steer incident light based on a position of the incident light on the light steering element.

The plurality of light sources may be configured to generate light of different wavelengths.

Wavelengths of light emitted from the plurality of light sources may sequentially change in the second direction.

A difference between peak wavelengths of light emitted from two neighboring light sources, from among the plurality of light sources, may be 50 nm or less.

A first light switching element among the plurality of light switching elements may optically connect the first waveguide to a first output element among the plurality of light input/output elements selectively based on an input electrical signal.

At least one of the plurality of switching elements may include a ring resonator and a tuning element configured to control the ring resonator to selectively resonate based on an electrical signal.

Control signals applied to at least two light switching elements among the plurality of light switching elements may overlap each other for a time duration.

The overlapping time duration between the control signals may be less than or equal to a settling time of each of the at least two light switching elements.

At least one of the plurality of light input/output elements may include at least one of a diffraction-based optical coupler or a mirror-based optical coupler. The light steering element may have a lens shape.

The light steering element may be configured to steer light incident from a plurality of first light input/output elements, among the plurality of light input/output elements, spaced apart from one another in the first direction to scan an external space in a fourth direction, and steer light incident from a plurality of second light input/output elements, among the plurality of light input/output elements, spaced apart from one another in the second direction to scan the external space in a fifth direction crossing the fourth direction.

One of the fourth and fifth directions may be an azimuth direction with respect to the external space, and the other of the fourth and fifth directions may be an elevation angle direction with respect to the external space.

The plurality of light input/output elements may be a first light input/output element configured to emit first light, and a second light input/output element configured to emit second light in a sequential manner, and the first light input/output element and the second light input/output element may not be adjacent to each other.

A first wavelength of the first light may be different from a second wavelength of the second light.

Among the plurality of light input/output elements, first light input/output elements in a same column may emit light at a first time, and second light input/output elements in a different column may emit light at a second time different from the first time.

At least one of the plurality of waveguides may include: the first waveguide; a first sub-waveguide optically connected to the first waveguide; and a second sub-waveguide optically connected to the first waveguide and spaced apart from the first sub-waveguide in the second direction, the plurality of light switching elements may include: n first sub-light switching elements optically connected to the first sub-waveguide; and n second sub-light switching elements optically connected to the second sub-waveguide, and the plurality of light input/output elements may include: n first sub-light input/output elements optically connected to the n first sub-light switching elements, respectively; and n second sub-light input/output elements optically connected to the n second sub-light switching elements, respectively, and wherein n is natural number equal to or greater than 3.

The LiDAR apparatus may further include a light distributor having a first end optically connected to the first waveguide, and a second end optically connected to the first sub-waveguide and the second sub-waveguide.

The LiDAR apparatus may further include a light amplifier optically coupled to at least one of the first and second sub-waveguides.

The LiDAR apparatus may further include a light attenuator optically coupled to at least one of the plurality of waveguides.

According to another aspect of the disclosure, there is provided a light detection and ranging (LiDAR) apparatus including: m waveguides, each extending in a first direction and spaced apart from one another in a second direction crossing the first direction; m light sources spaced apart from one another in the second direction, each of the m light sources having one end optically connected to a waveguide from among the m waveguides, corresponding to the respective light source from the m light sources; m×n light switching elements that are two-dimensionally spaced apart from one another in the first direction and the second direction, wherein n light switching elements that are spaced apart from one another in the first direction are optically connected to one of the m waveguides; m×n light input/output elements that are optically connected to the m×n light switching elements, respectively and input/output light in a third direction crossing the first direction and the second direction; and a light steering element that is arranged in the third direction from the m×n light input/output elements and configured to steer incident light based on a position of the incident light on the light steering element, wherein m is natural number equal to or greater than 3, and wherein n is natural number equal to or greater than 3.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of a light detection and ranging (LiDAR) apparatus according to an embodiment;

FIG. 2 is a block diagram of a light transmitter of a LIDAR apparatus that scans an external space by a plurality of rays, according to an embodiment;

FIG. 3 is a diagram showing a part of a LiDAR apparatus capable of emitting light one-dimensionally, according to an embodiment;

FIGS. 4A and 4B are diagrams showing an example of resonant wavelengths of a plurality of optical switching elements before trimming;

FIGS. 4C and 4D are diagrams showing an example of resonant wavelengths of a plurality of optical switching elements after trimming;

FIG. 5 is a diagram showing a relationship between an antenna array and a light steering element according to an embodiment;

FIG. 6 is a diagram showing a part of a LiDAR apparatus including an antenna array arranged two-dimensionally, according to an embodiment;

FIG. 7 is a diagram of a LiDAR apparatus including a first photodetector, according to an embodiment;

FIG. 8 is a reference diagram for illustrating an operating method of a LIDAR apparatus according to an embodiment;

FIG. 9 is a diagram showing a part of a LIDAR apparatus further including a monitoring detector, according to an embodiment;

FIG. 10 is a diagram showing a part of a LiDAR apparatus capable of performing two-dimensional scanning with one ray, according to another embodiment;

FIG. 11 is a diagram showing a part of a LIDAR apparatus including a phase shifter, according to an embodiment;

FIG. 12 is a diagram showing a part of a LiDAR apparatus further including an attenuator, according to an embodiment;

FIG. 13 is a diagram showing an example of a light input/output element including a reflector, according to an embodiment;

FIGS. 14 and 15 are conceptual diagrams showing an example in which a LiDAR apparatus according to an embodiment is applied to a vehicle;

FIG. 16 is a diagram showing a smartphone including a LiDAR apparatus according to an embodiment;

FIG. 17 is a diagram showing a tablet including a LiDAR apparatus according to an embodiment;

FIG. 18 is a diagram showing a laptop computer including a LiDAR apparatus according to an embodiment;

FIG. 19 is a diagram showing a smart refrigerator including a LIDAR apparatus according to an embodiment;

FIG. 20 is a diagram showing a security camera including a LIDAR apparatus according to an embodiment; and

FIG. 21 is a diagram showing a robot including a LiDAR apparatus according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

In an example case in which a layer, a film, a region, or a panel is referred to as being “on” another element, it may be directly on/under/at left/right sides of the other layer or substrate, or intervening layers may also be present. An expression used in the singular encompasses the expression of the plural, unless it has a clearly different meaning in the context. It will be further understood that when a portion is referred to as “comprising” another component, the portion may not exclude another component but may further comprise another component unless the context states otherwise.

The use of the term of “the above-described” and similar indicative terms may correspond to both the singular forms and the plural forms. Also, the steps of all methods described herein may be performed in any suitable order unless otherwise indicated herein or otherwise clearly contradicted by context.

Also, the terms “ . . . unit”, “ . . . module” used herein specify a unit for processing at least one function or operation, and this may be implemented with hardware or software or a combination of hardware and software. For example, the unit for processing at least one function or operation may be implemented by a processor or a circuit including electrical components. In another example, the unit for processing at least one function or operation may be implemented as a software code, a program code, an instruction set, etc., which is executed on a processor or a circuit including electrical components.

Furthermore, the connecting lines or connectors shown in the drawings are intended to represent example functional relationships and/or physical or logical couplings between the various elements. It should be noted that many alternative or additional functional relationships, physical connections, or logical connections may be present in a practical device.

Expressions such as “at least one of,” when preceding a list of elements, modify the entire list of elements and do not modify the individual elements of the list. For example, the expression, “at least one of a, b, and c,” should be understood as including only a, only b, only c, or a combination of two or more of A, B, and C such as ABC, AB, BC and AC.

When the terms “about” or “substantially” are used in this specification in connection with a numerical value, it is intended that the associated numerical value include a tolerance of ±10% around the stated numerical value. Moreover, when the words “generally” and “substantially” are used in connection with geometric shapes, it is intended that precision of the geometric shape is not required but that latitude for the shape is within the scope of the disclosure. Additionally, regardless of whether a value or shape is limited by “about” or “substantially,” such value and shape may be construed to include manufacturing or operating tolerance (e.g., ±10%) around the stated numerical value.

It will be understood that although the terms “first” and “second” are used herein to describe various elements, these elements should not be limited by these terms. Terms are only used to distinguish one element from other elements.

The use of any and all examples, or example language provided herein, is intended merely to better illuminate the disclosure and does not pose a limitation on the scope of the disclosure unless otherwise claimed.

Hereinafter, one or more embodiments will be described in detail with reference to accompanying drawings.

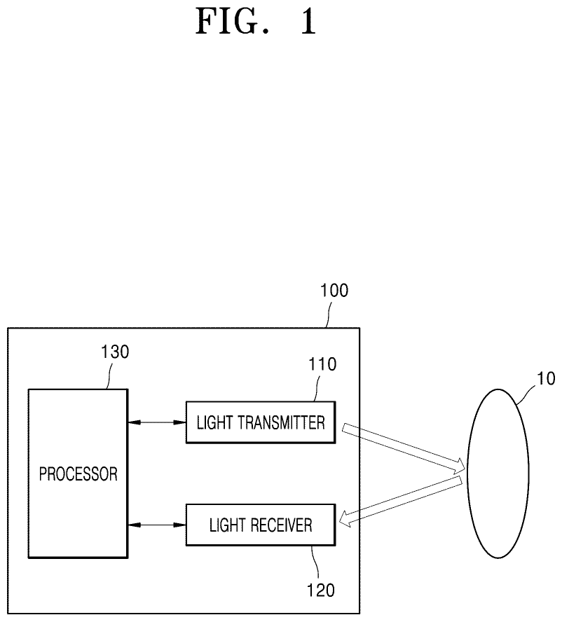

FIG. 1 is a block diagram of a light detection and ranging (LiDAR) apparatus 100 according to an embodiment. The LiDAR apparatus 100 may be used as a sensor for obtaining information about an object 10. For example, the LiDAR apparatus 100 may obtain three-dimensional (3D) information such as distance information to an object 10 in real-time. For example, the LiDAR apparatus 100 may be applied to or implemented in an unmanned vehicle, an autonomous driving vehicle, a robot, a drone, etc. However, the disclosure is not limited thereto, and as such, the LIDAR apparatus 100 may be applied to or implemented in one of various types of electronic devices. Referring to FIG. 1, the LiDAR apparatus 100 may include a light transmitter 110 radiating light to an external space, a light receiver 120 receiving light reflected from the external space in the light emitted to the external space, and a processor 130 configured to obtain a frame including distance information of the object 10 in the external space based on an electrical signal corresponding to the received light.

The LiDAR apparatus 100 may be implemented by a housing or a plurality of housings. In an example case in which the LiDAR apparatus 100 is implemented by the plurality of housings, a plurality of components may be connected via wires or wirelessly. For example, a first device may include the light transmitter 110 and the light receiver 120, and a second device may include the processor 130. Here, the first device may be implemented in a first housing, and the second device may be implemented in a second housing. The LiDAR apparatus 100 may be implemented as a part of another apparatus performing another functions, e.g., an autonomous driving apparatus.

Although only some components related to help with the understanding of the embodiment in the LiDAR apparatus 100 are shown in FIG. 1, the disclosure is not limited thereto, and as such, according to other embodiments, other electronic components may be further included in the LiDAR apparatus 100. For example, the LIDAR apparatus 100 may further include a memory.

The memory is hardware for storing various data processed in the LiDAR apparatus 100, for example, the memory may include data processed or to be processed in the LiDAR apparatus 100. Also, the memory may store applications, drivers, etc. to be driven by the LiDAR apparatus 100.

The memory may include a random-access memory (RAM) such as dynamic random access memory (DRAM), static RAM (SRAM), etc., a read-only memory (ROM), an electrically erasable programmable read-only memory (EEPROM), CD-ROM, Blu-ray or another optical disc storage, hard disk drive (HDD), solid state drive (SSD), or flash memory, and moreover, may further include another storage device that may access the LiDAR apparatus 100.

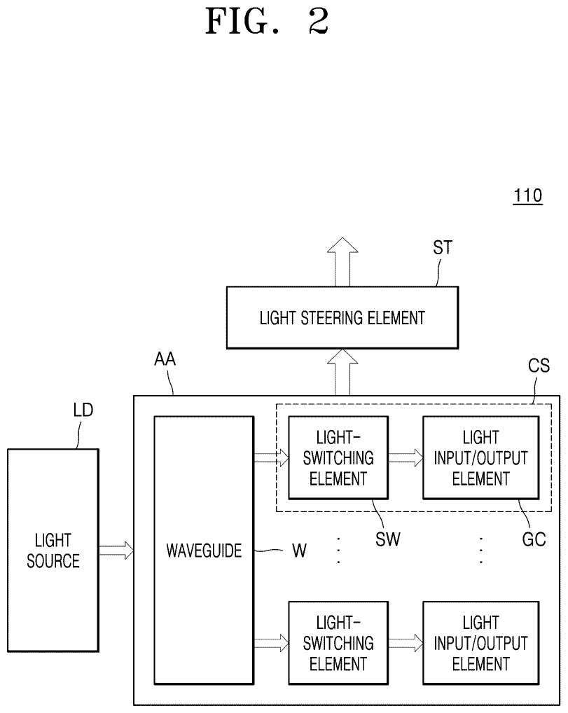

FIG. 2 is a block diagram of the light transmitter 110 of the LiDAR apparatus 100 that scans an external space with a plurality of rays, according to an embodiment. As shown in FIG. 2, the light transmitter 110 may include a light source LD that generates light, an antenna array AA that emits the light generated from the light source LD from spatially different locations in a certain direction, and a light steering element ST that steers the light incident from the antenna array AA in different directions according to incident points of the light on the light steering element ST.

The light source LD may be a device configured to generate light of an infrared ray band. In an example case in which the light of the infrared ray band is used, mixing with natural light of a visible ray band including solar light may be prevented. However, one or more embodiments are not limited thereto, and as such, according to another embodiment, the light source LD may include a light source generating light of various different wavelength bands and may include a plurality of sub-light sources each generating light of different wavelength. Also, each of the sub-light sources may radiate pulse light or continuous light. A plurality of light sources LD may sequentially generate light with certain time differences therebetween.

The light source LD may include a laser diode (LD), an edge emitting laser, a vertical-cavity surface emitting laser (VCSEL), a distributed feedback laser, a light-emitting diode (LED), a super luminescent diode (SLD), etc. However, one or more embodiments are not limited thereto, and as such, according to another embodiment, another type of light emitting device may be used as the light source LD.

The antenna array AA may include at least one waveguide W, a plurality of light switching elements SW, and a plurality of light input/output elements GC respectively corresponding to the plurality of light switching elements SW. The antenna array AA may emit light, which propagates in a direction parallel to a first plane, in a direction crossing the first plane. For example, the first plane may be an XY plane and the direction crossing the first plane may be a Z-axis direction. One light switching element SW and one light input/output element GC corresponding to the light switching element SW may be referred to as one antenna CS. The waveguide W, the plurality of light switching elements SW, and the plurality of light input/output elements GC may be formed on one substrate SUB. All components in the light transmitter 110 are integrated on one substrate SUB. For example, all components in the light transmitter 110 are integrated as on-chip type or another type of semiconductor chip.

The waveguide W may propagate the incident light through internal total reflection. The waveguide W may be arranged on an upper surface of the substrate SUB. In some embodiments, the waveguide W propagating the incident light through internal total reflection may also be referred to as the waveguide W progressing the incident light through internal total reflection.

The plurality of light input/output elements GC may be spatially arranged to be spaced apart from one another. The plurality of light input/output elements GC may be arranged one-dimensionally or two-dimensionally. The number of the plurality of light input/output elements GC may be in proportional to a scanning resolution of the LiDAR apparatus 100 according to an embodiment. In an example case in which the plurality of light input/output elements GC are one-dimensionally arranged, the LIDAR apparatus 100 may one-dimensionally scan the external space. According to an embodiment, the LiDAR apparatus 100 may perform two-dimensional scanning by adding another component (e.g., a driver for moving the substrate SUB). In an example case in which the plurality of light input/output elements GC are two-dimensionally arranged, the LiDAR apparatus 100 may two-dimensionally scan the external space.

The plurality of light switching elements SW may respectively correspond to the plurality of light input/output elements GC. Each of the plurality of light switching elements SW may selectively transfer the light propagating in the waveguide W to the corresponding light input/output element. For example, the plurality of light switching elements SW may respectively transfer the light propagating in the waveguide W to the corresponding light input/output elements according to electrical signals applied thereto.

According to an embodiment, each of the plurality of light input/output elements GC may emit the light transferred from the corresponding light switching element SW in a third direction. According to an embodiment, one or more of the plurality of light input/output elements GC may include a diffraction-based optical coupler or a reflection-based optical coupler. However, the disclosure is not limited thereto, and as such, at least one of the plurality of light input/output elements GC may include a diffraction-based optical coupler and a reflection-based optical coupler.

The light steering element ST may steer the light incident from the antenna array AA (or the plurality of light input/output elements GC) in a certain direction based on the incident point on the light steering element ST. The light steering element ST may scan the external space in an azimuth direction (or referred to as ‘horizontal direction’) by using some antennas of the antenna array AA, and may scan the external space in an elevation angle direction (or referred to as ‘vertical direction’) by using another antenna in the antenna array AA.

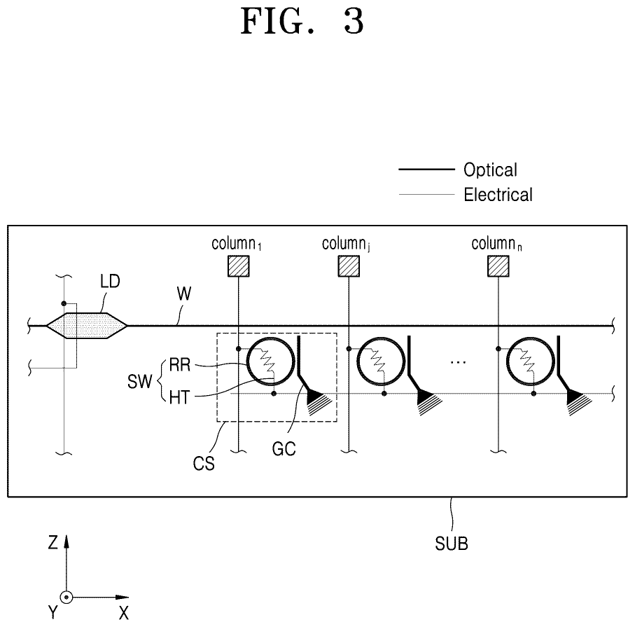

FIG. 3 is a diagram showing a part of a LiDAR apparatus capable of emitting light one-dimensionally, according to an embodiment.

The LiDAR apparatus may include one light source LD, one waveguide W, a plurality of light switching elements SW, and a plurality of light input/output elements GC. The light source LD may emit light of a certain wavelength. The light source LD is described above with reference to FIG. 2, and thus detailed descriptions thereof are omitted.

The waveguide W may extend in the first direction. For example, the waveguide W may extend in the first direction (e.g., X-axis direction). One end of the waveguide W may be optically connected to the light source LD. The light generated from the light source LD may be incident on the waveguide W. The waveguide W may allow the incident light to propagate in an extending direction of the waveguide W, that is, the first direction. Hereinafter, ‘optically connected’ may be referred to as ‘connected’.

According to an embodiment, each of the plurality of light switching elements SW may be arranged to be optically connected to the waveguide W without physically contacting the waveguide W. However, the disclosure is not limited thereto, and as such, according to an embodiment, one or more of the plurality of light switching elements SW may physically contact the waveguide W. According to an embodiment, the plurality of light switching elements SW may be arranged so as not to be optically coupled to each other in a direction parallel to the extending direction of the waveguide W.

Each of the light switching elements SW may include a ring resonator RR. The ring resonator RR may be arranged to be optically connected to the waveguide W without physically contacting the waveguide W. The ring resonator RR may be a closed loop resonator having a ring-shaped waveguide W. The ring resonator RR may selectively resonate the light propagating along the waveguide W. The wavelength of resonating light may vary depending on a diameter of the ring resonator RR or a circumferential length of the ring-shaped waveguide.

Each of the light switching elements SW may further include a tuning element HT. The tuning element HT may adjust the resonating wavelength of the ring resonator RR. For example, the tuning element HT may be configured to fine tune the resonating wavelength of the ring resonator RR by finely adjusting the resonating wavelength. The tuning element HT may change the phase of the light propagating along the ring resonator RR. In an example case in which the phase of the light is changed, the optical length of the closed-loop waveguide W, and thus the resonating wavelength of the ring resonator RR may be changed. In an example case in which a phase delay of the light increases, the optical length of the closed-loop waveguide W increases and the resonating wavelength of the ring resonator RR increases, and in another example case in which the phase delay of the light decreases, the optical length of the closed-loop waveguide W decreases and the resonating wavelength of the ring resonator RR may decrease.

The tuning element HT may be implemented by changing the temperature of the ring resonator RR or changing a concentration of a carrier (e.g., electrons or holes). For example, in the temperature changing method, the resonating wavelength of the ring resonator RR may be adjusted by changing a temperature around the ring resonator RR and changing a refractive index of the ring resonator RR. Also, in the carrier concentration changing method, the resonating wavelength of the ring resonator RR may be adjusted by locating a diode junction around the center of the ring resonator RR and changing the carrier concentration to change the refractive index of the ring resonator RR.

According to an embodiment, one tuning element HT may be arranged in each of the ring resonators RR as shown in FIG. 3. However, the disclosure is not limited thereto, and as such, according to another embodiment, a plurality of tuning elements HT may be arranged in each of the ring resonators RR.

The tuning element HT may be controlled by an electrical signal applied by the processor 130. The processor 130 may adjust the resonating wavelength of the ring resonator RR by controlling the tuning element HT. In an example case in which the resonating wavelength of the ring resonator RR matches the wavelength of the light propagating in the corresponding waveguide W, the light propagating in the waveguide W may be transferred to the ring resonator RR and then may be transferred to the light input/output element GC.

The processor 130 may control the tuning element HT so that the plurality of light switching elements SW connected to one waveguide W may be resonated with the light of same wavelength (that is, the light propagating in the waveguide W). The ring resonator RR may resonate at light of different wavelengths due to a process distribution, etc.

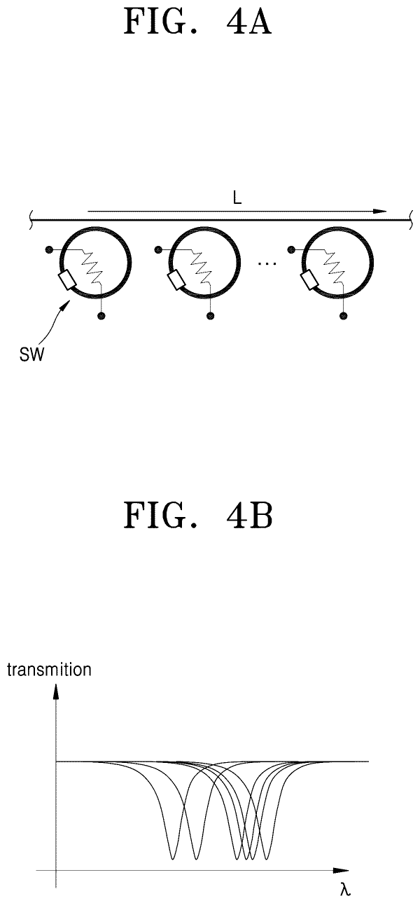

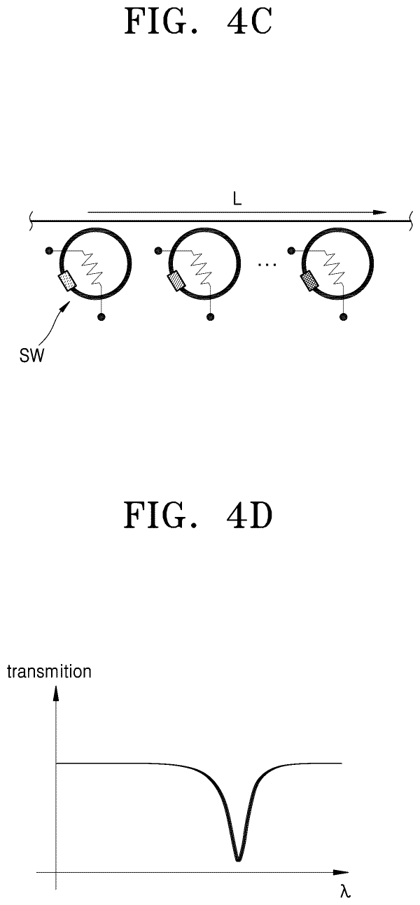

FIGS. 4A and 4B are diagrams showing an example of resonating wavelengths of the plurality of optical switching elements SW before trimming. In FIG. 4A shows an example of a waveguide through which the light propagates, a plurality of ring resonators, and a plurality of tuning elements to which electrical signals are not applied, and FIG. 4B is a graph showing a transmittance of the light detected at one end of the waveguide. As shown in FIGS. 4A and 4B, the ring resonators may have different resonating wavelengths due to the process distribution, etc. Therefore, the plurality of ring resonators need to be trimmed, that is, controlled by the tuning elements so as to have the same resonating wavelength.

FIGS. 4C and 4D are diagrams showing an example of resonant wavelengths of a plurality of optical switching elements after trimming. In FIG. 4C shows an example of the waveguide through which the light propagates, a plurality of ring resonators, and a plurality of tuning elements after the ring resonators are trimmed to resonate the light of the same wavelength, and FIG. 4D is a graph showing a transmittance of the light detected at one end of the waveguide. As shown in FIGS. 4C and 4D, in an example case in which an electrical signal is applied to each of the tuning elements so that the light of the same wavelength may be resonated, it would be predicted that the transmittance of the light detected at one end of the waveguide is greatly reduced at the same wavelength. The electrical signals applied to the tuning elements for allowing the plurality of ring resonators to resonate the light of the same wavelength may be identical with or different from one another.

In an example case in which the ring resonator RR of the light switching element SW resonates and transfers the light propagating through the waveguide W to the light input/output element GE, the switching element SW or the tuning element HT may be referred to as ‘being in on-state’ or ‘being turned on’.

The light switching element SW transfers the light propagating in the waveguide W to the light input/output element GC, and the light input/output element GC may emit the transferred light in the third direction. In an example case in which the light propagates in the waveguide W and the plurality of light switching elements SW are sequentially turned on one-by-one, the plurality of light input/output elements GC may emit the light one-by-one. As such, the antenna array AA may emit the light from spatially different positions by one at a time. The light emitted from the different light input/output elements GC may have different phases. However, embodiments of the disclosure are not limited thereto, and as such, according to another embodiment, the plurality of light input/output elements GC may emit light simultaneously. For example, the plurality of light input/output elements GC may emit light simultaneously provided that there is no cross-talk. That is, the plurality of light input/output elements GC are configured to emit light simultaneously with no cross-talk.

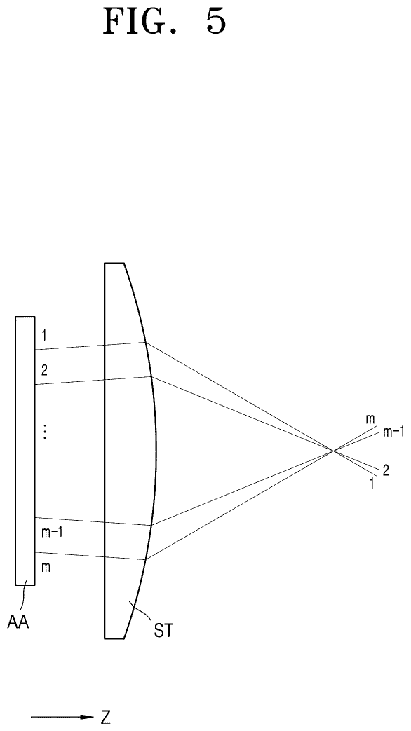

FIG. 5 is a diagram showing a relationship between the antenna array AA and the light steering element ST according to an embodiment. Referring to FIG. 5, the light steering element ST may be arranged in the third direction (e.g., the Z-direction) from the antenna array AA. The light steering element ST may steer the incident light in a certain direction based on the position of incident light. As shown in FIG. 5, the light steering element ST may be formed in a lens shape. For example, the antenna array AA may be arranged on a focal plane of the light steering element ST. The antenna array AA arranged on the focal plane of the light steering element ST may be referred to as a focal plane array. The light emitted from the antenna array AA may be steered in different directions according to the incident points onto the light steering element ST.

In an example case in which the light source LD is in turned on state, the light generated by the light source LD may propagate through the waveguide W. For example, from among the plurality of light switching elements SW, a first light switching element SW is turned on and the other light switching elements SW may be turned off according to the control from the processor 130. Then, a first light input/output element GC corresponding to the first light switching element SW that is in the turned on state may receive the light propagating in the waveguide W via the light switching element SW and emit the light in the third direction. The light is incident on the light steering element ST and may be steered based on the point incident on the light steering element ST. According to the above principles, the location of light emitted from the antenna array AA is changed because the light switching element SW that is in turned on state is changed, and as the location of light emitted from the antenna array AA is changed, the incident point of the light on the light steering element ST is also changed. In addition, the light steering element ST may steer the light in different directions and output the light to the external space based on the incident point of the light on the light steering element ST. According to an embodiment, the LiDAR apparatus 100 may scan the external space in the horizontal direction (or azimuth direction) or vertical direction (or elevation angle direction) by using the antenna array AA that is arranged one-dimensionally.

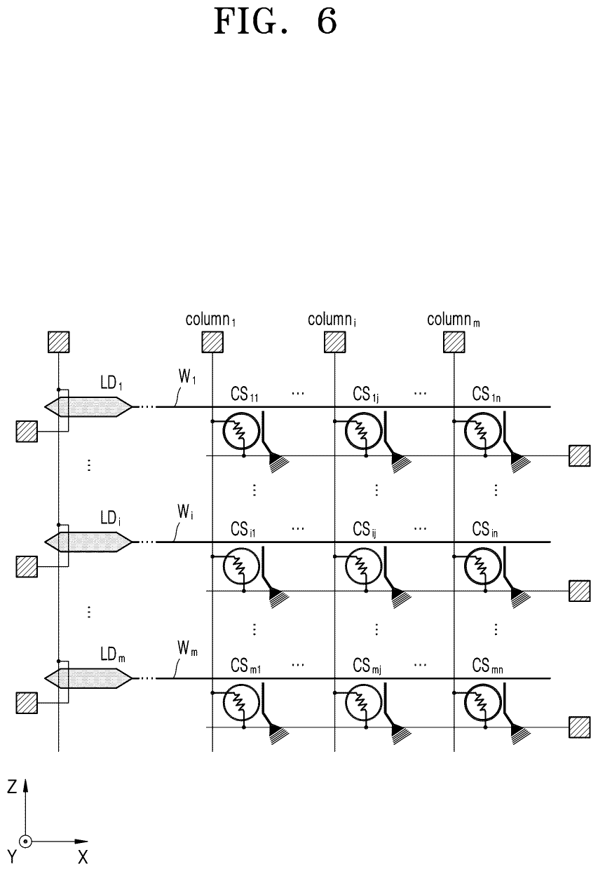

FIG. 6 is a diagram showing a part of a LIDAR apparatus including the antenna array AA arranged two-dimensionally, according to an embodiment. Referring to FIG. 6, the antenna array AA of the LiDAR apparatus may include m waveguides W (m is 3 or greater natural number), each of the m waveguides W extending in the first direction and arranged spaced apart from each other in the second direction crossing the first direction, and m×n light switching elements SW including n switching elements arranged in the first direction and m switching elements arranged in the second direction to be spaced apart from one another. From among m×n light switching elements SW, the n switching elements (n is 3 or greater natural number) that are arranged spaced apart from one another in the first direction may be optically connected to one of m waveguides W.

The LiDAR apparatus 100 may further include m×n light input/output elements GC that respectively correspond to the m×n light switching elements SW and input/output the light applied from the light switching elements SW in the third direction. In other words, the plurality of light switching elements SW and the plurality of light input/output elements GC may be arranged in an m×n matrix form. In FIG. 6, CSᵢₖ may denote an antenna including a light switching element SW arranged at a coordinate (i,k) and a corresponding light input/output element GC.

The LiDAR apparatus 100 may further include m light sources LD which are spaced apart from one another in the second direction and each have one end optically connected to one of the m waveguides W. Each of the m light sources LD may generate light of different wavelengths. For example, wavelengths of the light emitted from the m light sources LD may be sequentially changed in the second direction. A difference between the wavelengths of light emitted from two neighboring light sources LD, from among the m light sources LD, may be 50 nm or less. However, the embodiments of the disclosure are not limited thereto, and as such, according to another embodiment, the difference between the wavelengths of light emitted from two neighboring light sources LD, from among the m light sources LD, may be different than 50 nm or less.

According to an embodiment, a first light switching elements SW, among the m×n light switching elements SW may selectively connect a first waveguide W corresponding to the first light switching elements SW, from among the m waveguides W, to a first light input/output element GC corresponding to first light switching elements SW, from among the m×n light input/output elements GC. For example, the first light switching elements SW may selectively connect the first waveguide W to the first light input/output element GC based on an input electrical signal. For example, the light switching element SW at (i,j) may optically connect the waveguide W arranged in an i-th row to the light input/output element GC arranged at (i,j).

According to an embodiment, the processor 130 of the LIDAR apparatus 100 may control the light source LD and the light switching element SW so as to scan the external space while turning on the m×n light input/output elements GC one by one. For example, the light source LD and the light switching element SW may be controlled so that a first light input/output element GC emits first light, and then, a second light input/output element GC that is not adjacent to the first light input/output element GC emits second light. Here, the first light and the second light may have the same wavelengths or different wavelengths.

According to an embodiment, the LiDAR apparatus 100 may control the antenna AA so that the light may be emitted in a column unit from among the plurality of antennas arranged in the m×n matrix. For example, the antennas in a first column emit light one by one, and then, the antennas in a second column may emit light one by one.

The light steering element ST may steer the light so that the light emitted from the antennas in the same column scans the external space in a fourth direction and the light emitted from the same row scans the external space in a fifth direction. Here, one of the fourth and fifth directions may be an elevation angle direction (or vertical direction) and the other may be an azimuth direction (or horizontal direction). For example, the fourth direction may be the elevation angle direction and the fifth direction may include the azimuth direction.

The light transmitter 110 of the LiDAR apparatus may be implemented in an optical phased array (OPA) method. For example, the light transmitter 110 may include a plurality of light modulators and a plurality of grid-type antennas. The light transmitter 110 may further include a plurality of light distributors and a plurality of waveguides. The scanning direction of the light may be the azimuth direction (or horizontal direction) according to phases of the light provided to the plurality of grid-type antennas, and the scanning direction of the light may be the elevation angle direction (or vertical direction) according to wavelengths of the light provided to the plurality of grid-type antennas. The scanning resolution in the elevation angle direction may be restricted by a tuning range of the wavelength. Also, whenever performing the scanning in the azimuth angle direction, a phase of each grid-type antenna has to be controlled.

According to an embodiment, the LiDAR apparatus may include a plurality of light sources LD and a plurality of light switching elements SW that independently operate, and thus, the light may be effectively scanned in various directions. Also, because the components may be integrated on one substrate SUB, the miniaturization of the LiDAR apparatus may be implemented.

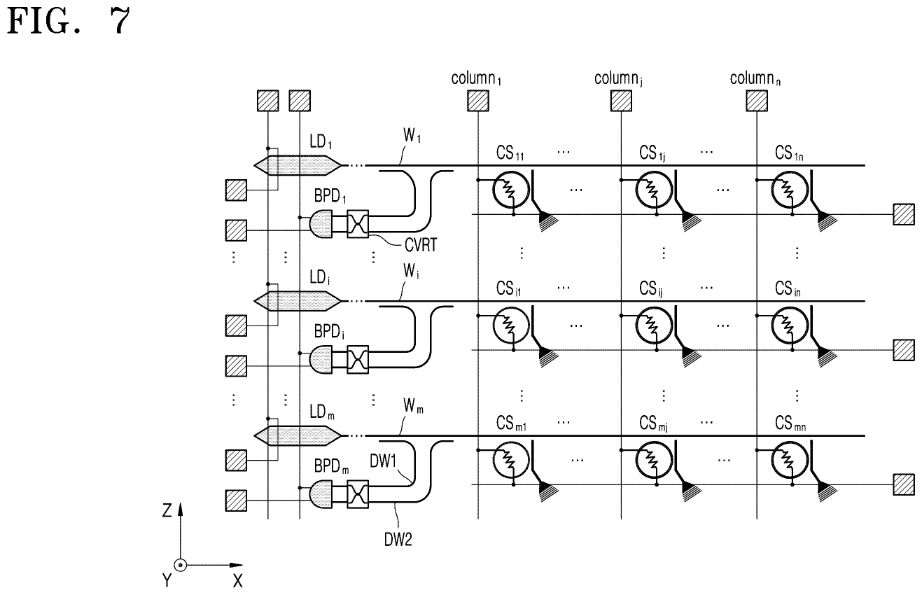

FIG. 7 is a diagram of a LiDAR apparatus including a first photodetector BPD, according to an embodiment. Comparing FIG. 6 with FIG. 7, the LiDAR apparatus of FIG. 7 may further include m first photodetectors BPD that are arranged spaced apart from one another in the second direction.

The m first photodetectors BPD may be spaced apart from one another to correspond to m waveguides W. The first photodetector BPD may include a photodiode, a photodiode array, a photo transistor, or a photo transistor array for receiving light and generating current according to the intensity of the light. For example, the first photodetector BPD may include an avalanche photodiode (APD).

According to an embodiment, a first detecting waveguide DW1 and a second detecting waveguide DW2 may be arranged between each of the first photodetectors BPD and the corresponding waveguide W. For example, the first detecting waveguide DW1 may transfer the light output from the light source LD to the first photodetector BPD and a second detecting waveguide DW2 may transfer the light received from the antenna array AA to the first photodetector BPD. According to an embodiment, a converter CVRT may be arranged on the first detecting waveguide DW1 and second detecting waveguide DW2. For example, the converter CVRT may be arranged above the first detecting waveguide DW1 and second detecting waveguide DW2. The converter CVRT may be configured to convert the propagating light into a digital type to be input into the first photodetector BPD.

The light receiver 120 may include the waveguide W, the antenna array AA, and the plurality of first photodetectors BPD. The light transmitter 110 and the light receiver 120 may be arranged on one substrate SUB. The waveguide W and the antenna array AA of the light receiver 110 may be shared with the light receiver 120.

The processor 130 may determine distance information or speed information about an object existing in the external space based on signals received from the first photodetectors BPD. For example, the distance information or speed information about the object in the external space may be determined in a frequency modulated continuous wave (FMCW) method by using data received from the first photodetectors BPD. For example, the processor 130 may extract the distance information or speed information of the outside object by using a time of flight (ToF) method or the FMCW method.

For example, light generated from the light source LD₁ arranged in a first row, from among the m light sources LD, may propagate to the waveguide W₁ arranged in the first row. Some of the light propagating in the waveguide W₁ arranged in the first row may be applied to the first photodetector BPD₁ arranged in the first row via the first detecting waveguide, and some of the light propagating in the waveguide W₁ may be incident on the light steering element ST via an antenna CS₁₁ at a point (1, 1) from among the plurality of antennas arranged in the m×n matrix. The light steering element ST steers the light based on the incident point on the light steering element ST, and the steered light is reflected by the object existing in the external space and then may be incident on the antenna CS₁₁ at the point (1,1) via the light steering element ST. The light received by the antenna CS₁₁ at the point (1,1) may be incident on the first photodetector arranged in the first row via the waveguide W₁ arranged in the first row and the second detecting waveguide. The processor 130 may calculate a distance to the object by using the light received from the first photodetector BPD₁ arranged in the first row.

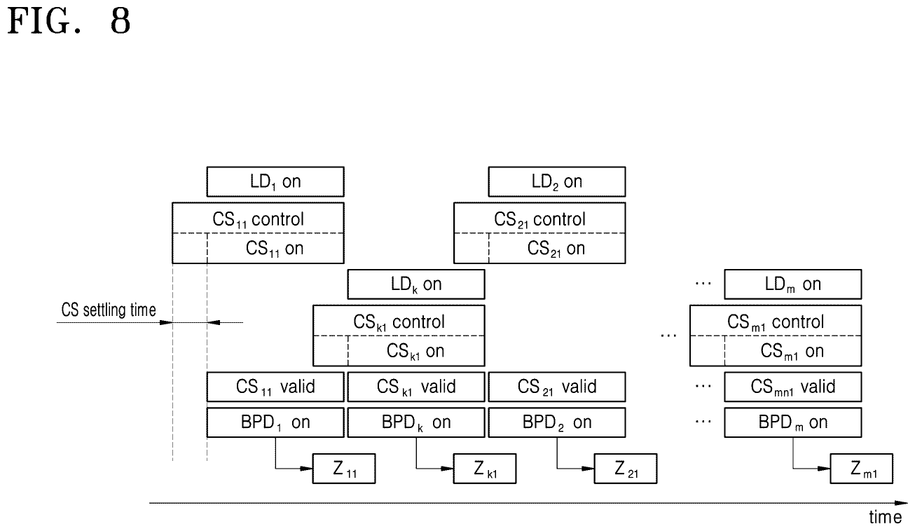

FIG. 8 is a reference diagram for illustrating a method of operating a LIDAR apparatus according to an embodiment.

The time duration of a control signal from the processor 130 for the light switching element SW to perform the light transfer between the waveguide W and the light input/output element GC may be divided as a settling time and an on-time. The settling time may denote a time duration from a point in time when the control signal is applied to the light switching element SW to a point in time when the light switching element SW starts to transfer the light. During the on-time, the light input/output element GC may transfer light. The time duration of the control signal from the processor 130 with respect to the light source LD may be divided as a settling time and an on-time.

The settling time of the light source LD and the settling time of the light switching element SW may be different from each other. The settling time of the light source LD may be less than the settling time of the light switching element SW. For example, the settling time of the light source LD may be 100 ns, whereas the settling time of the tuning element HT may be about 1 us to about 2 us. Therefore, after the processor 130 applies the control signal to the light switching element SW, the processor 130 may apply the control signal to the corresponding light source LD in consideration of the settling time of the light switching element SW.

Referring to FIG. 8, the processor 130 may control the light source LD and the light switching element SW so that the antenna CS₁₁ at the point (1,1) emits light. The processor 130 may control the light source LD and the light switching element SW considering the settling time of the light source LD and the light switching element SW. In an example case in which the light is to be transferred/received via the antenna CS₁₁ at the point (1,1), the processor 130 may control the antenna array AA so that the antenna CS₁₁ at the point (1,1) is turned on and the other antennas are turned off. Even in a case in which the control signal is applied to the light switching element SW₁ of the antenna CS₁₁ at the point (1,1), the light switching element SW₁ may not be turned on until the settling time passes. For example, the processor 130 may apply the control signal to the light switching element SW₁, and after that, the processor 130 may apply the control signal to the light source after the time obtained by subtracting the settling time of the light source LD₁ from the settling time of the light switching element SW₁ has passed. Then, the antenna at the point (1,1) becomes a valid antenna CS₁₁, and the light generated from the light source LD₁ in the first row is emitted to the external space via the waveguide W₁ in the first row, the antenna CS₁₁ at the point (1,1), and the light steering element ST. In addition, in the emitted light, the light reflected by the object may be detected by the first photodetector BPD₁ in the first row via the light steering element ST, the antenna CS₁₁ at the point (1,1), and the waveguide W₁ in the first row. The processor 130 may calculate a distance Z₁₁ to the object by using the light generated from the light source LD₁ in the first row and the light received via the antenna CS₁₁ at the point (1,1).

According to an embodiment, the processor 130 may emit the light from a certain antenna CS, and then, may emit the light from an antenna CS that is not adjacent to the certain antenna. For example, after calculating the distance to the object via the antenna CS₁₁ at the point (1,1), the processor 130 may calculate the distance to the object by using the antenna that is not adjacent to the antenna CS₁₁ at the point (1,1), for example, an antenna CSₖ₁ arranged at a point (k,1) (here, k is a natural number equal to or greater than m/2+1). As described above, in an example case in which the distance to the object is calculated sequentially by using the antennas that are not adjacent to each other, the cross-talk between neighboring light switching elements SW may be prevented.

In an example case in which applying a control signal to the antenna CSₖ₁ at the coordinate (k,1), the processor 130 may apply the control signal to the antenna CSₖ₁ at the point (k,1) before the antenna CS₁₁ at the point (1,1) is turned off, in consideration of the settling time of the light switching element SW. For example, based on the point in time when the antenna CS₁₁ at the point (1,1) is turned off, the control signal may be applied to the antenna CSₖ₁ disposed at the point (k,1) as early as the settling time of the light switching element SW. Durations of the control signal applied to the antenna CS₁₁ at the point (1,1) and the control signal applied to the antenna CSₖ₁ at the point (k,1) may partially overlap each other. The overlapping time duration of the control signals may be the settling time duration. In an example case in which the light switching elements SW are controlled so that the settling times do not overlap, there may be an idling time during which the scanning is not performed as long as the settling time, in the scanning time. In an example case in which the settling time of next antenna overlaps the duration during which the light is emitted from a certain antenna, the idling time of not performing the scanning operation may be removed to reduce the scanning period.

The processor 130 may calculate the distance to the object by using the m antennas arranged in the first column, in an order of the antenna CS₁₁ at (1,1), the antenna CSₖ₁ at (k,1), an antenna CS₂₁ at (2,1), an antenna CSₖ₊₁₁ at (k+1, 1), . . . , and an antenna CSₘ₁ at (m,1). Next, the processor 130 may calculate the distances to the object up to the n-th column in the way of calculating the distance to the object by using the m antennas in the second column.

The processor 130 may perform the scanning operation by using the antennas in the column unit, but is not limited thereto. The scanning may be performed by using the antennas arranged in the row unit provided that the scanning may be performed by using the light from the antennas that are not adjacent to each other.

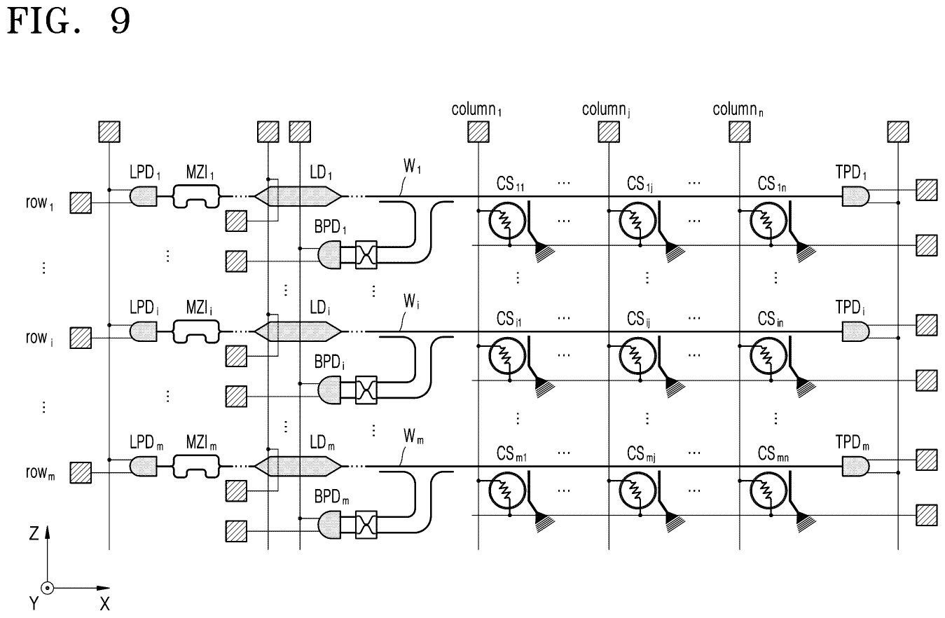

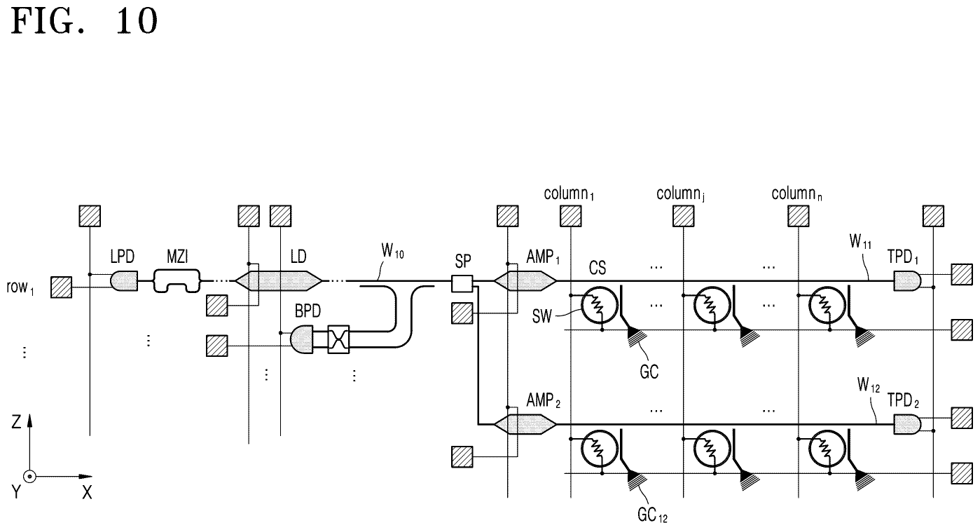

FIG. 9 is a diagram showing a part of a LIDAR apparatus further including a monitoring detector, according to an embodiment.

Comparing FIG. 7 with FIG. 9, a first monitoring detector TPD may be further arranged at the other end of each waveguide W. The first monitoring detector TPD may detect light.

The processor 130 may determine the control signal of the light switching element SW by using the first monitoring detector TPD. In an example case in which the tuning element HT is not in tuned state, the corresponding ring resonator RR may not resonate. The light generated from the light source LD may be incident on the first monitoring detector TPD by passing through the ring resonator RR without resonating in the ring resonator RR, and an output value from the first monitoring detector TPD may be equal to or greater than a reference value.

The processor 130 may control the tuning element HT so that the output value from the first monitoring detector TPD is less than or equal to the reference value, and may determine the control signal, which is applied to the tuning element HT based on a determination that the output value from the first monitoring detector TPD is less than or equal to the reference value, as the control signal for turning on the tuning element HT. The processor 130 may perform the above-described operations on every light switching element SW. According to the control signal applied to each tuning element HT, the ring resonator RR corresponding to the tuning element HT may resonate or may not resonate with the light propagating in the waveguide W.

According to an embodiment, the LiDAR apparatus 100 may further include second monitoring detectors LPD for monitoring the light sources LD. The second monitoring detector LPD may be arranged at the other end of the light source LD, and a phase difference generator MZI may be further disposed between the second monitoring detector LPD and the light source LD. The second monitoring detector LPD may include a linearity photodetector. The phase difference generator MZI may include an asynchronous Mach-Zehnder interferometer (MZI). The second monitoring detector LPD may be used to control a frequency modulation of the light source LD to have linearity.

Some of the light generated from the light source LD may be incident on the second monitoring detector LPD via the phase difference generator MZI. The phase difference generator MZI may include a plurality of waveguides having different lengths. For example, the phase difference generator MZI may separate a passage of the waveguide into two and delays the light propagating in one passage, and then, combine the light that has propagated through a plurality of waveguides. As such, the light passing through the phase difference generator MZI may include a plurality of rays of light having different passages.

The second monitoring detector LPD may detect a “beating” frequency component based on the passage difference of the light received from the phase difference generator MZI. In an example case in which the frequency of the light source LD linearly changes over time, the beating frequency may be consistent. However, in an example case in which the frequency of the light source LD does not change linearly over time, the beating frequency may change over time. The processor 130 may feedback the control from the light source LD by monitoring the beating frequency over time.

FIG. 10 is a diagram showing a part of the LiDAR apparatus 100 capable of performing two-dimensional scanning with one ray, according to another embodiment. Comparing FIG. 7 with FIG. 10, in the LiDAR apparatus 100 of FIG. 10, at least one of the m waveguides W may include a first waveguide W₁₀, a first sub-waveguide W₁₁ optically connected to the first waveguide W₁₀, and a second sub-waveguide W₁₂ that is optically connected to the first waveguide W₁₀ and spaced apart from the first sub-waveguide W₁₁ in the second direction. The m×n light switching elements include n first sub-switching elements SW₁₁ optically connected to the first sub-waveguide W₁₁ and n second sub-switching elements SW₁₂ optically connected to the second sub-waveguide W₁₂, and the m×n light input/output elements GC may include n first sub light input/output elements GC₁₁ optically connected to the n first sub-switching elements SW₁₁ respectively and n second sub light input/output elements GC₁₂ optically connected to the n second sub-switching elements SW₁₂, respectively.

The LiDAR apparatus 100 may further include a light distributor SP having one end optically connected to the first waveguide W₁₀ and the other end optically connected to the first and second sub-waveguides W₁₁ and W₁₂, and a first amplifier AMP₁ optically connected to the first sub-waveguide W₁₁ and a second amplifier AMP₂ optically connected to the second sub-waveguide W₁₂. Thus, n first sub-switching elements SW₁₁ and n second sub-switching elements SW₁₂ may be selectively connected to one light source LD.

In an example case in which the first amplifier AMP₁ is turned on and the second amplifier AMP₂ is turned off, the light generated from the light source LD may scan the external space via the first sub light input/output element GC₁₁ optically connected to the first sub-waveguide W₁₁. In an example case in which the first amplifier AMP₁ is turned off and the second amplifier AMP₂ is turned on, the light generated from the light source LD may scan the external space via the second sub light input/output element GC₁₂ optically connected to the second sub-waveguide W₁₂. In an example case in which both the first and second amplifiers AMP₁ and AMP₂ are turned on, the light reflected by the object is simultaneously incident on the antenna from various angles, and thus, it may be difficult for the first photodetector BPD to correctly measure the distance to the object.

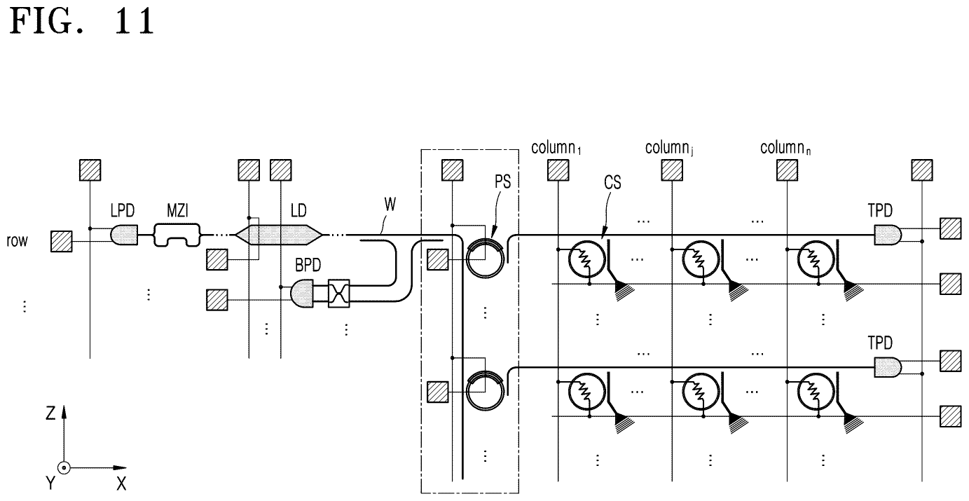

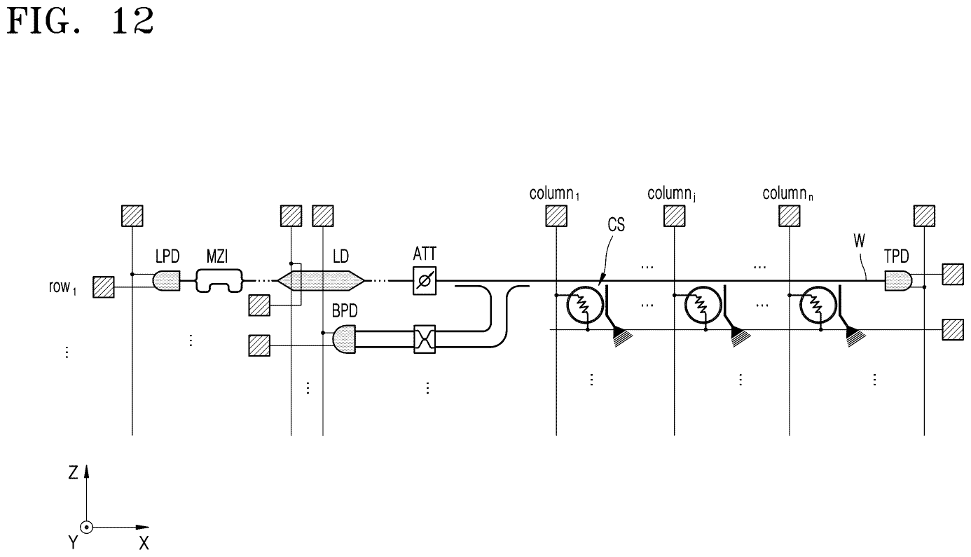

FIG. 11 is a diagram showing a part of the LiDAR apparatus 100 including a phase shifter PS, according to an embodiment. Comparing FIG. 7 with FIG. 11, the LiDAR apparatus 100 of FIG. 11 may further include one or more phase shifters PS between the light source LD and the antenna array AA. In an example case in which there are a plurality of phase shifters PS, the plurality of phase shifters PS may be spaced apart from one another in the second direction. The waveguide is arranged between the light source LD and the phase shifter PS, and sub-waveguides may be arranged between the phase shifter PS and the antennas arranged in a row. The phase shifter PS may include a PN diode. Two-dimensional scanning may be performed with one light source LD by using the phase shifter PS.

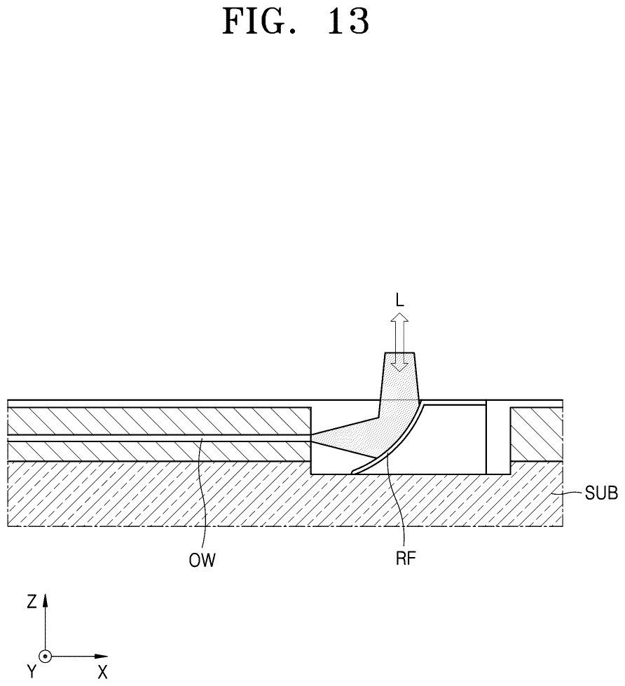

FIG. 12 is a diagram showing a part of the LiDAR apparatus 100 further including an attenuator ATT, according to an embodiment. Comparing FIG. 7 with FIG. 12, the LiDAR apparatus of FIG. 12 may further include the attenuator ATT arranged on the waveguide W. The attenuator ATT may adjust the intensity of light propagating in the waveguide W. Each attenuator ATT may adjust the intensity of the light output from the corresponding light source LD and transfer the light to the antennas. The attenuator ATT may adjust the intensity of light so that the intensity of the light output from each light source LD may be uniform. In an example case in which the intensity of the light reflected from the object and incident on the antenna is too high and thus affects the stability of the light source LD, the attenuator ATT may reduce the intensity of the light output from the light source LD and adjust the intensity of the light incident on the antenna. For example, based on a determination that the intensity of the light reflected from the object and incident on the antenna is higher than a reference value, the attenuator ATT may reduce the intensity of the light output from the light source LD and adjust the intensity of the light incident on the antenna. The adjustment of the light intensity may be performed by using a signal output from a first detector.

According to an embodiment, the light input/output element GC of the LIDAR apparatus 100 may be a diffraction-based optical coupler. However, one or more embodiments are not limited thereto. The light input/output element GC may include a reflection-based optical coupler.

FIG. 13 is a diagram showing an example of the light input/output element GC including a reflector RF, according to an embodiment. As shown in FIG. 13, the light input/output element GC may include a waveguide OW and the reflector RF. The reflectors RF may be configured to reflect the light output from the waveguide OW in the third direction and reflect the light input towards reflectors RF through the waveguide OW. The reflector RF may be curved. The reflector RF may be inclined with respect to the substrate SUB by about 450. Therefore, the light propagating in the direction parallel to the XY plane may propagate in the Z-axis direction due to the reflector RF. Moreover, the light propagating in the Z-axis direction towards the reflector RF may propagate in the XY plane due to the reflector RF.

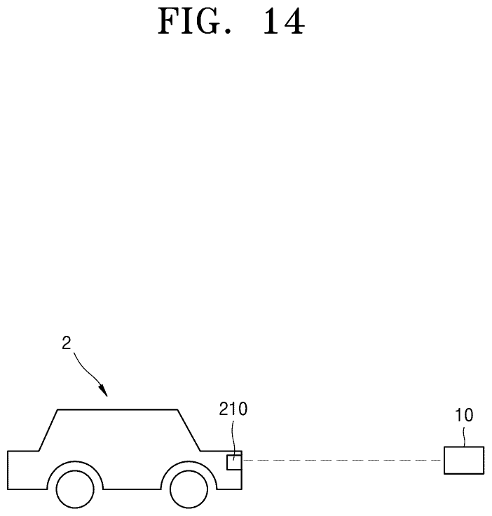

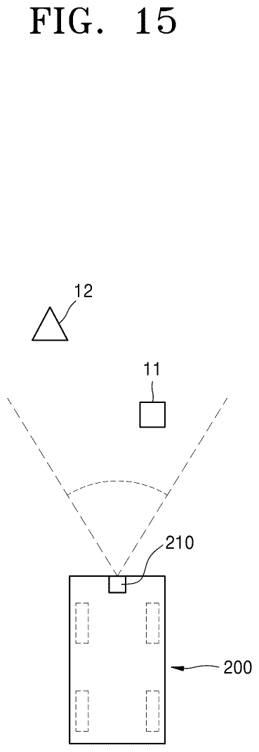

FIGS. 14 and 15 are conceptual diagrams showing an example in which a LIDAR apparatus according to an embodiment is applied to a vehicle.

Referring to FIGS. 14 and 15, a LIDAR apparatus 210 may be applied to a vehicle 200, and information about an object 10 may be obtained by using the LiDAR apparatus 210. For example, the LiDAR apparatus 210 may be provided in the vehicle 200 or attached to the vehicle 200. For example, the LiDAR apparatus 210 may be attached to a front side of the vehicle 200 or a rear side the vehicle 200. However, the disclosure is not limited thereto, and as such, the LiDAR apparatus 210 may be attached to any portion of the vehicle 200. The vehicle 200 may have an autonomous driving function. The LiDAR apparatus 210 may detect an object or a person in the proceeding direction of the vehicle 200. Here, the object or the person may be referred to as object 10. The LiDAR apparatus 210 may measure a distance to the object 10 based on information such as time difference between a transmission signal and a detected signal. As shown in FIG. 15, the LiDAR apparatus 210 may obtain information about a close object 11 and a far object 12 within a scanning range.

According to an embodiment, the LiDAR apparatus may be, but is not limited to, a smart phone, a smart watch, a mobile phone, a personal digital assistant (PDA), a laptop, a personal computer (PC), various wearable devices, other mobile or non-mobile computing devices, and internet-of-things (IoT) devices.

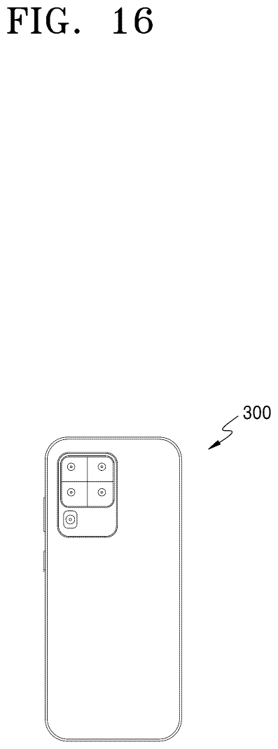

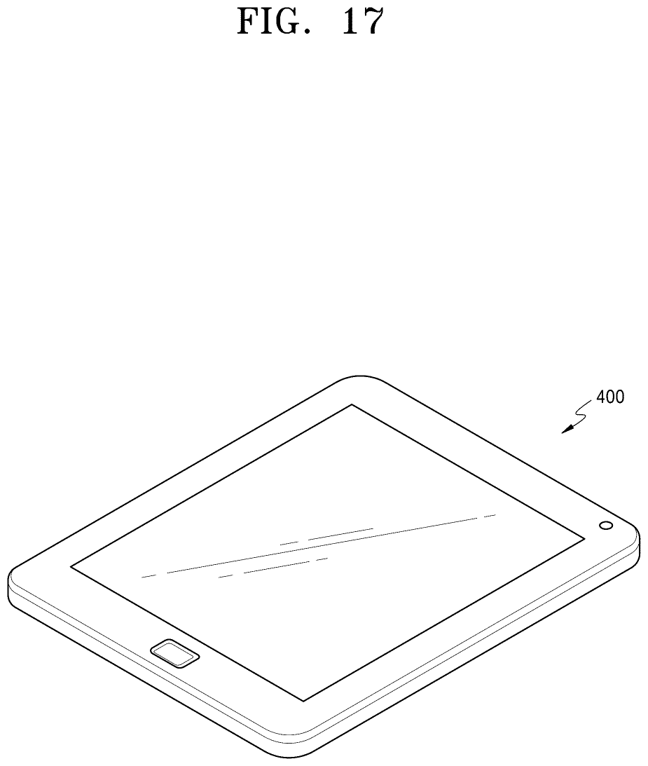

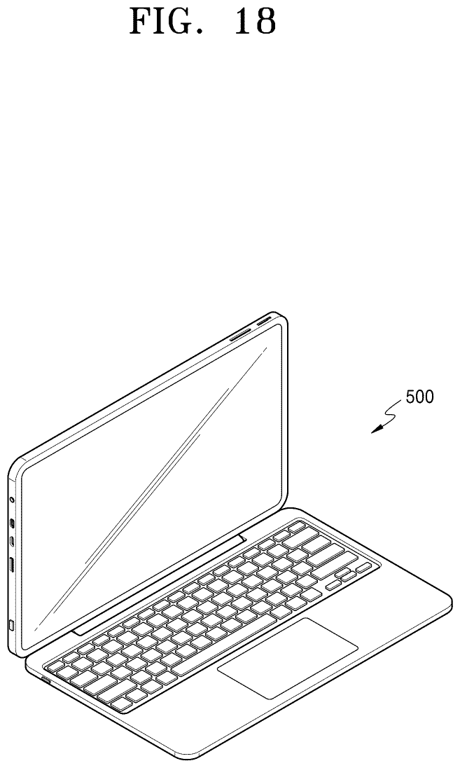

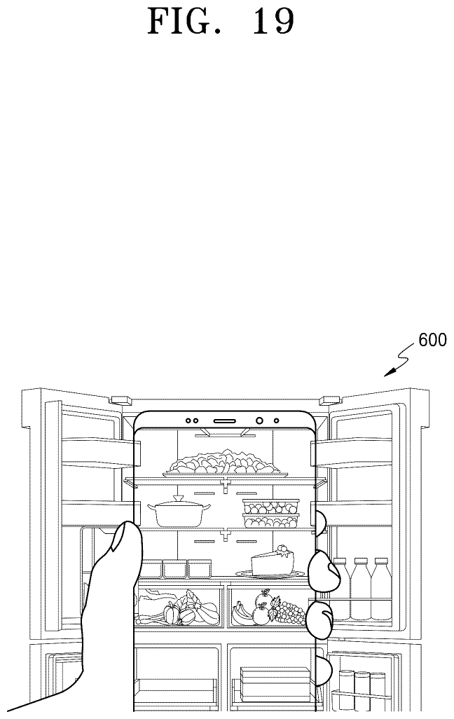

FIG. 16 is a diagram showing an example of a smartphone 300 including the LiDAR apparatus according to an embodiment, FIG. 17 is a diagram showing an example of a tablet 400 including the LiDAR apparatus according to an embodiment, and FIG. 18 is a diagram showing an example of a laptop computer 500 including the LIDAR apparatus according to an embodiment. The smartphone 300, the tablet 400, the laptop 500, etc. may use the LiDAR apparatus which is a 3D object sensor to extract object depth information from images, adjust out-of-focus of images, or automatically identify objects in images.

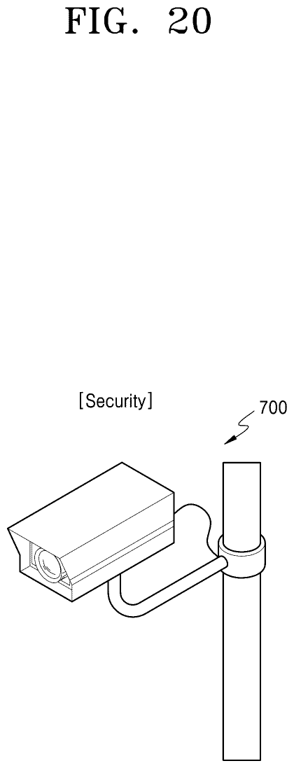

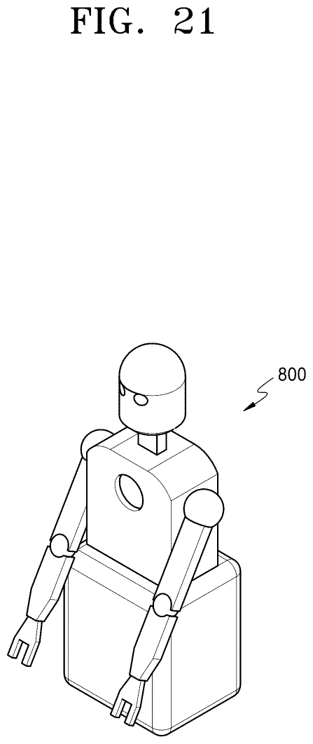

FIG. 19 is a diagram showing an example of a smart refrigerator 600 including the LiDAR apparatus according to an embodiment, FIG. 20 is a diagram showing an example of a security camera 700 including the LiDAR apparatus according to an embodiment, and FIG. 21 is a diagram showing an example or a robot 800 including the LiDAR apparatus according to an embodiment.

An electronic apparatus including the LiDAR apparatus may be applied to the smart refrigerator 600 of FIG. 19, the security camera 700 of FIG. 20, the robot 800 of FIG. 21, etc. For example, the smart refrigerator 600 may automatically recognize food in the refrigerator by using an image sensor, and may notify the user of an existence of a certain kind of food, kinds of food put into or taken out, etc. through a smartphone. The security camera 700 may recognize objects or persons in images even in a dark environment. The robot 800 may be input to a disaster or industrial site that a person may not directly access, to provide the user with 3D images.

The method of controlling the processor 130 may be recorded in a computer-readable recording medium having recorded thereon at least one program including instructions for executing the method. Examples of computer-readable media include magnetic media such as hard disks, floppy disks, and magnetic tape; optical media such as CD ROM disks and DVD; magneto-optical media such as floptical disks; and hardware devices that are specially to store and perform program commands, such as read-only memory (ROM), random access memory (RAM), flash memory, etc. Examples of the program instructions may include machine language codes generated by a compiler and high-level language codes executable by an interpreter.

According to an aspect of the disclosure, the LiDAR apparatus may operate at high speed by electro-optically controlling switches.

According to an aspect of the disclosure, the LiDAR apparatus may be miniaturized because the light source, the photodetector, the antenna, etc. are integrated on one chip.

According to an aspect of the disclosure, the LiDAR apparatus may perform a calibration operation on the chip by arranging a monitoring element on the chip.

According to an aspect of the disclosure, the LiDAR apparatus may extract distance information and speed information about an outside object in an FMCW method.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A light detection and ranging (LiDAR) apparatus comprising:
a plurality of waveguides extending in a first direction, the plurality of waveguides spaced apart from one another in a second direction crossing the first direction;
a plurality of light sources spaced apart from one another in the second direction, each of the plurality of light sources having a first end optically connected to a waveguide from among the plurality of waveguides, corresponding to the respective light source from the plurality of light sources;
a plurality of light switching elements that are two-dimensionally spaced apart from one another in the first direction and the second direction, a plurality of first light switching elements, among the plurality of light switching elements, that are spaced apart from one another in the first direction are optically connected to a first waveguide among the plurality of waveguides;
a plurality of light input/output elements optically connected to the plurality of light switching elements, respectively, the plurality of light input/output elements configured to output light in a third direction crossing the first direction and the second direction or receive external light; and
a light steering element arranged in the third direction from the plurality of light input/output elements, the light steering element configured to steer incident light based on a position of the incident light on the light steering element.

2. The LiDAR apparatus of claim 1, wherein the plurality of light sources are configured to generate light of different wavelengths.

3. The LiDAR apparatus of claim 1, wherein wavelengths of light emitted from the plurality of light sources sequentially change in the second direction.

4. The LiDAR apparatus of claim 1, wherein a difference between peak wavelengths of light emitted from two neighboring light sources, from among the plurality of light sources, is 50 nm or less.

5. The LiDAR apparatus of claim 1, wherein a first light switching element among the plurality of light switching elements optically connects the first waveguide to a first output element among the plurality of light input/output elements selectively based on an input electrical signal.

6. The LiDAR apparatus of claim 1, wherein at least one of the plurality of switching elements comprises a ring resonator and a tuning element configured to control the ring resonator to selectively resonate based on an electrical signal.

7. The LiDAR apparatus of claim 1, wherein control signals applied to at least two light switching elements among the plurality of light switching elements overlap each other for a time duration.

8. The LiDAR apparatus of claim 7, wherein the overlapping time duration between the control signals is less than or equal to a settling time of each of the at least two light switching elements.

9. The LiDAR apparatus of claim 1, wherein at least one of the plurality of light input/output elements comprises at least one of a diffraction-based optical coupler or a mirror-based optical coupler.

10. The LiDAR apparatus of claim 1, wherein the light steering element has a lens shape.

11. The LiDAR apparatus of claim 1, wherein the light steering element is configured to:
steer light incident from a plurality of first light input/output elements, among the plurality of light input/output elements, spaced apart from one another in the first direction to scan an external space in a fourth direction, and
steer light incident from a plurality of second light input/output elements, among the plurality of light input/output elements, spaced apart from one another in the second direction to scan the external space in a fifth direction crossing the fourth direction.

12. The LiDAR apparatus of claim 11, wherein
one of the fourth and fifth directions is an azimuth direction with respect to the external space, and
the other of the fourth and fifth directions is an elevation angle direction with respect to the external space.

13. The LiDAR apparatus of claim 1, wherein, the plurality of light input/output elements comprises a first light input/output element configured to emit first light, and a second light input/output element configured to emit second light in a sequential manner, and
wherein the first light input/output element and the second light input/output element are not adjacent to each other.

14. The LiDAR apparatus of claim 13, wherein a first wavelength of the first light is different from a second wavelength of the second light.

15. The LiDAR apparatus of claim 1, wherein, from among the plurality of light input/output elements, first light input/output elements in a same column emit light at a first time, and second light input/output elements in a different column emit light at a second time different from the first time.

16. The LiDAR apparatus of claim 1, wherein
at least one of the plurality of waveguides comprises:
the first waveguide;
a first sub-waveguide optically connected to the first waveguide; and
a second sub-waveguide optically connected to the first waveguide and spaced apart from the first sub-waveguide in the second direction, the plurality of light switching elements comprise:
n first sub-light switching elements optically connected to the first sub-waveguide; and
n second sub-light switching elements optically connected to the second sub-waveguide, and
the plurality of light input/output elements comprise:
n first sub-light input/output elements optically connected to the n first sub-light switching elements, respectively; and
n second sub-light input/output elements optically connected to the n second sub-light switching elements, respectively, and
wherein n is natural number equal to or greater than 3.

17. The LiDAR apparatus of claim 16, further comprising:
a light distributor having a first end optically connected to the first waveguide, and
a second end optically connected to the first sub-waveguide and the second sub-waveguide.

18. The LiDAR apparatus of claim 16, further comprising a light amplifier optically coupled to at least one of the first and second sub-waveguides.

19. The LiDAR apparatus of claim 1, further comprising a light attenuator optically coupled to at least one of the plurality of waveguides.

20. A light detection and ranging (LiDAR) apparatus comprising:
m waveguides, each extending in a first direction and spaced apart from one another in a second direction crossing the first direction;
m light sources spaced apart from one another in the second direction, each of the m light sources having one end optically connected to a waveguide from among the m waveguides, corresponding to the respective light source from the m light sources;
m×n light switching elements that are two-dimensionally spaced apart from one another in the first direction and the second direction, wherein n light switching elements that are spaced apart from one another in the first direction are optically connected to one of the m waveguides;
m×n light input/output elements that are optically connected to the m×n light switching elements, respectively and input/output light in a third direction crossing the first direction and the second direction; and
a light steering element that is arranged in the third direction from the m×n light input/output elements and configured to steer incident light based on a position of the incident light on the light steering element,
wherein m is natural number equal to or greater than 3, and
wherein n is natural number equal to or greater than 3.
